(19) United States
(12) Patent Application Publication
(10) Pub. No.: US 2005/0072263 A1
(43) Pub. Date: Apr. 7, 2005

(54) Automotive foot pedal and method of manufacture

(76) Inventor: Jeffrey G. Gibson, Bellaire, MI (US)

Correspondence Address: JOHN R. BENEFIEL, 280 DAINES ST., #100 B, BIRMINGHAM, MI, 48009, US

(21) Appl. No.: 10/680,559

(22) Filed: Oct. 6, 2003

(51) Int. Cl. G05G 1/14

(52) U.S. Cl. 74/560

(57) ABSTRACT

A high strength and stiffness foot pedal includes a tubular metal core and an overmolded plastic component including a foot pad at one end of the pedal and a pivot lug at the other end.

### BACKGROUND OF THE INVENTION

This invention concerns foot pedals used in automotive vehicles such as to operate the brake and clutch.

Such pedals have typically been constructed of steel, with a foot pad holder installed on one end and pivot mount hardware installed on the other. A rubber foot pad is then assembled onto the pad holder.

While this arrangement has proved to operate satisfactorily, it has heretofore been recognized that a molded plastic pedal would offer the advantages of being lower in weight and cheaper to manufacture, as these components could be integrated together.

U.S. Pat. No. 5,533,421 describes such a molded plastic foot pedal, as does U.S. Pat. No. 6,553,864.

However, in the case of a brake pedal, demanding strength requirements apply, since a brake pedal must withstand the forces imposed thereon in a crash with the driver's foot fully depressing the pedal, (such forces can be on the order of 250 pounds) and thereafter still be fully operational.

Furthermore, the driver's foot can be offset on the pad so as to impose considerable torsional stress on the pedal arm.

The molded plastic pedal designs heretofore proposed cannot meet such demanding strength requirements.

It is the object of the present invention to provide an integrally molded pedal construction which is capable of providing the strength necessary for use as an automotive brake pedal.

### SUMMARY OF THE INVENTION

The above object and other objects which will become apparent upon a reading of the following specification and claims are achieved by molding an outer plastic overlayer onto a core metal tube, which plastic overlayer also forms the foot pad and upper pivot mounting feature. The metal tube is made sufficiently strong, as by being constructed of a heavy walled steel tube, to be adequate to resist the potentially high torsional and bending stresses in this type of application. The overmolded plastic is preferably of a glass filled high strength plastic such as nylon or PBT.

Thus, an integrated pedal results which is sufficiently strong to meet automotive brake pedal strength requirements.

### DESCRIPTION OF THE DRAWINGS

FIG. 1 is a perspective view of a foot pedal according to the present invention.

FIG. 2 is a longitudinal sectional view of the brake pedal shown in FIG. 1.

FIG. 3 is a view of the section 3-3 taken in FIG. 1.

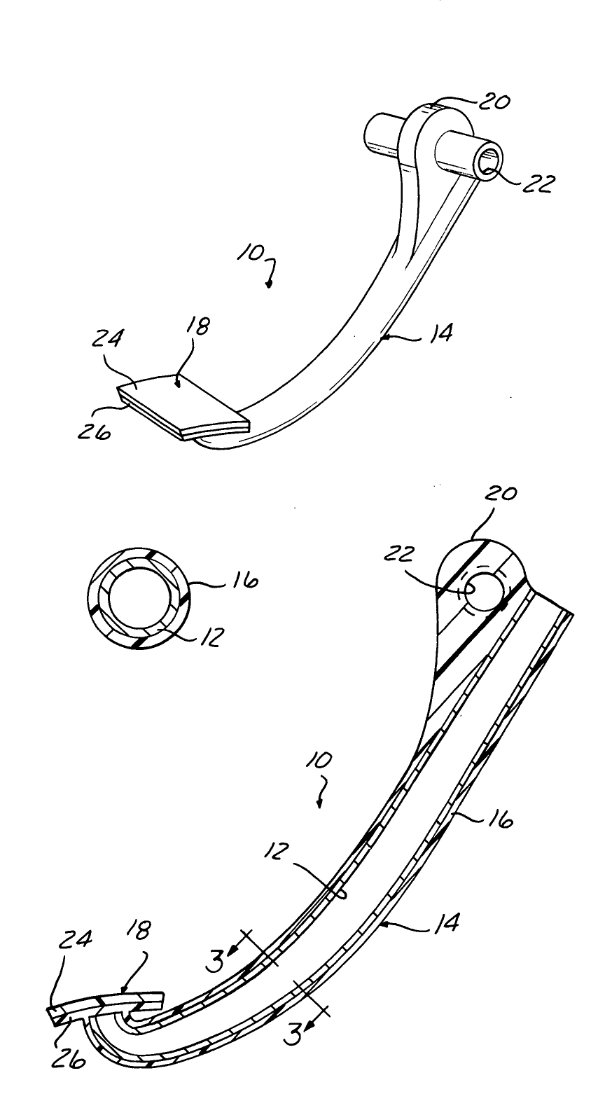

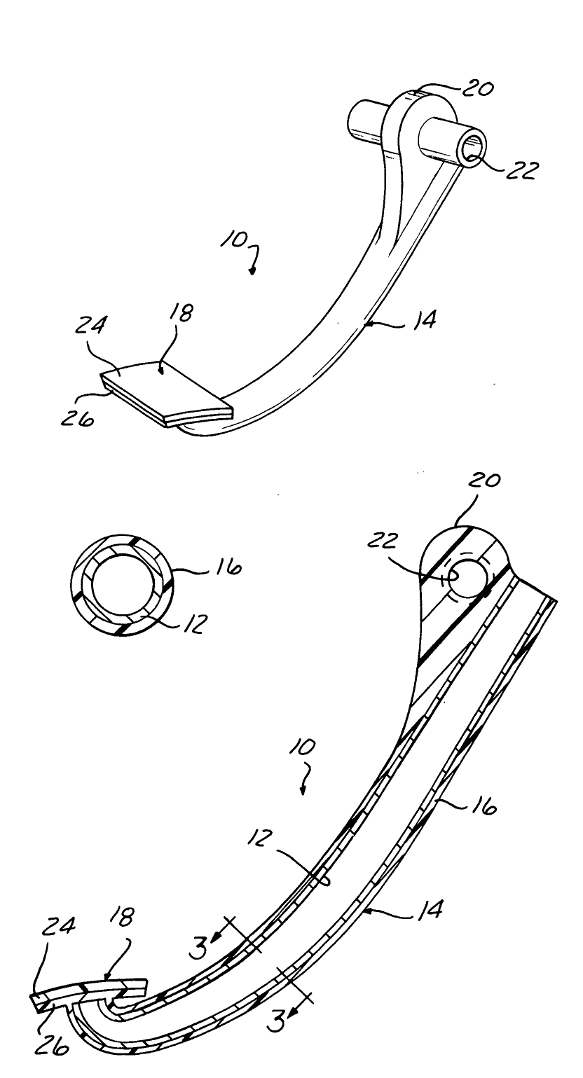

### DETAILED DESCRIPTION

In the following detailed description, certain specific terminology will be employed for the sake of clarity and a particular embodiment described in accordance with the requirements of 35 USC 112, but it is to be understood that the same is not intended to be limiting and should not be so construed inasmuch as the invention is capable of taking many forms and variations within the scope of the appended claims.

Referring to the drawings, a pedal 10 is shown including an elongated lever body 14 which is formed of a metal tubular core 12, of a sufficient stiffness and wall thickness to meet the bending and torsional stiffness and strength requirements of a brake pedal. Steel is the preferred material as it is low cost and strong, but aluminum or other suitable strong metals can be used to further reduce weight.

The tubular core 12 can be angled or curved as shown to be adapted to any desired pedal configuration.

An overmolded plastic component 16 encloses the tubular core 12, and in addition forms a foot pad 18 at one end, and a pivot lug 20 at the other end. The pivot lug 20 is formed with a hole 22 for mounting the pedal 10 at its upper end in the conventional fashion.

The foot pad 18 could optionally be formed by a two stage molding process in which a softer plastic ribbed cover 24 is mold bonded to a support pad 26 of the same plastic material as the component 14.

Overmolded component 16 is preferably constructed of a high strength plastic such as a glass filled nylon or PBT.

As described in U.S. Pat. No. 5,533,421, the cover 24 may be ribbed and of softer plastic than component 16 such as a thermoplastic elastomer.

Thus, the brake pedal 10 has a high resistance to torsional and bending forces to be able to meet the demanding requirements for brake pedals, while being lighter weight and cheaper to manufacture than conventional brake pedal. The same construction can be used for clutch and other pedals.

1. A foot pedal for use as an automotive brake or clutch operator, comprising:
an elongated lever body comprised of a metal tubular core;
a plastic overmolded component at least partially enclosing said metal tubular core, said plastic overmolded component including an integrally formed foot pad at one end of said elongated lever body and a pivot lug at the other end.

2. The pedal according to claim 1 wherein said tubular core is constructed of steel.

3. The pedal according to claim 1 wherein said overmolded component is molded from a glass filled plastic.

4. The pedal according to claim 1 wherein said elongated lever body is curved.

5. The pedal according to claim 3 wherein said plastic comprises nylon.

6. A method of manufacturing an automotive brake pedal comprising the steps of:
forming an elongated lever body from a steel tubular core;
said step of forming an elongated lever body further including the step of overmolding a plastic component at least partially over said steel tubular core;
said step of overmolding said plastic component further including the step of molding a foot pad integral therewith at one end of said elongated lever body and a pivot lug at the other end thereof.

7. The method according to claim 6 wherein a glass filled plastic is used to overmold said plastic component.

8. The method according to claim 6 wherein said step of forming an elongated lever body further includes the step of forming said tubular core into a curved shape.
